(19) United States
(12) Patent Application Publication
(10) Pub. No.: US 2011/0094132 A1
(43) Pub. Date: Apr. 28, 2011

(54) Greeting Cards with Three-Dimensional Images and Viewing Glasses

(76) Inventors: Joe DeFranco, Solon, OH (US); Joshua Jenniges, Fairview Park, OH (US)

(21) Appl. No.: 12/911,962

(22) Filed: Oct. 26, 2010

Related U.S. Application Data
(60) Provisional application No. 61/255,182, filed on Oct. 27, 2009.

(51) Int. Cl. G09F 1/04

(52) U.S. Cl. 40/124.06; 40/124.09; 40/124.17; 40/124.01

(57) ABSTRACT

A three-dimensional greeting card having anaglyph or stereographic images and/or text printed thereon that may be viewed using 3D filter glasses that are releasably attached to the body of the greeting card. The glasses are attached along a perforation located along one edge of the greeting card. The glasses contain two film lenses, each lens being a different color. The images and/or text printed upon the greeting card body contain two superimposed images that are each made of a specific color that will be viewed differently behind each film lens contained in the 3D glasses.

### RELATED APPLICATIONS

This applications claims priority to U.S. Provisional Patent Application No. 61/255,182 filed on Oct. 27, 2009, which is incorporated by reference herein in its entirety.

### FIELD OF THE INVENTION

The present invention relates to social expression products and more specifically to greeting cards having anaglyph images that when viewed through accompanying anaglyph filter glasses, create the effect of a three-dimensional (3D) image.

### BACKGROUND OF THE INVENTION

Anaglyph images have been in existence for over 150 years. Anaglyph images are used to provide a stereoscopic three-dimensional effect, when viewed with specially colored glasses. The image is made up of two color layers which are superimposed but offset with respect to each other to create the illusion of depth. Typically, a main figure is located in the center of the picture and the background and foreground are shifted laterally in opposite directions. The picture contains two differently filtered colored images, one for each eye. The glasses used to view the anaglyph images typically have a red filter contained within the left lens and a blue/green/cyan filter contained within the right lens which results in each eye seeing a slightly different picture. The red filter allows only the red part of the image through to the left eye while the blue/green/cyan lens allows only the blue and green parts of the image through to the right eye. Each eye therefore sees a different perspective. The brain blends together the images it receives from each eye and interprets the differences as being the result of different distances. Anaglyph images are most commonly used to enhance the entertainment value of video games, movies and television programs.

### SUMMARY OF THE INVENTION

### Description of the Drawings

FIG. 1 is a top view of a card blank for the 3D greeting card with glasses of the present invention.

FIG. 2 is a perspective view of the front of the 3D greeting card with glasses of FIG. 1.

FIG. 3 is a perspective view of the inside of the 3D greeting card body with detached glasses.

FIG. 4 is a perspective view of the front of the greeting card body and glasses.

FIG. 5 is a perspective view of the back of the 3D greeting card with glasses.

### DETAILED DESCRIPTION OF PREFERRED AND ALTERNATE EMBODIMENTS

The greeting card of the present disclosure and related inventions combines a traditional greeting card having one or more anaglyph or stereoscopic images and/or text with anaglyph or stereoscopic viewer glasses.

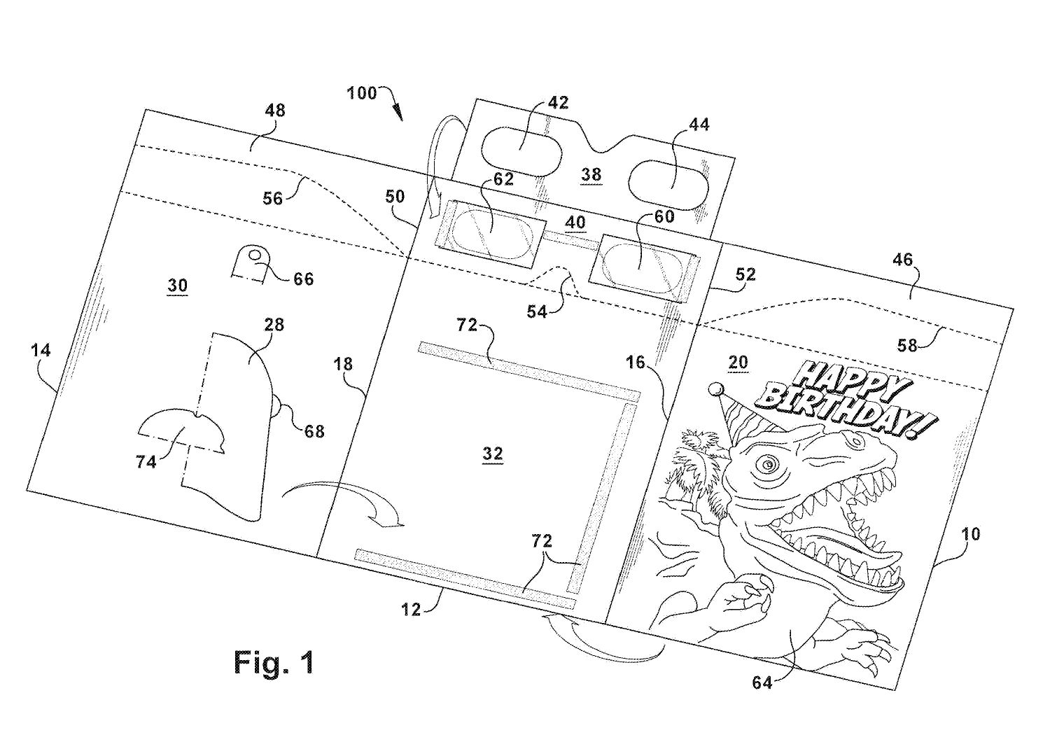

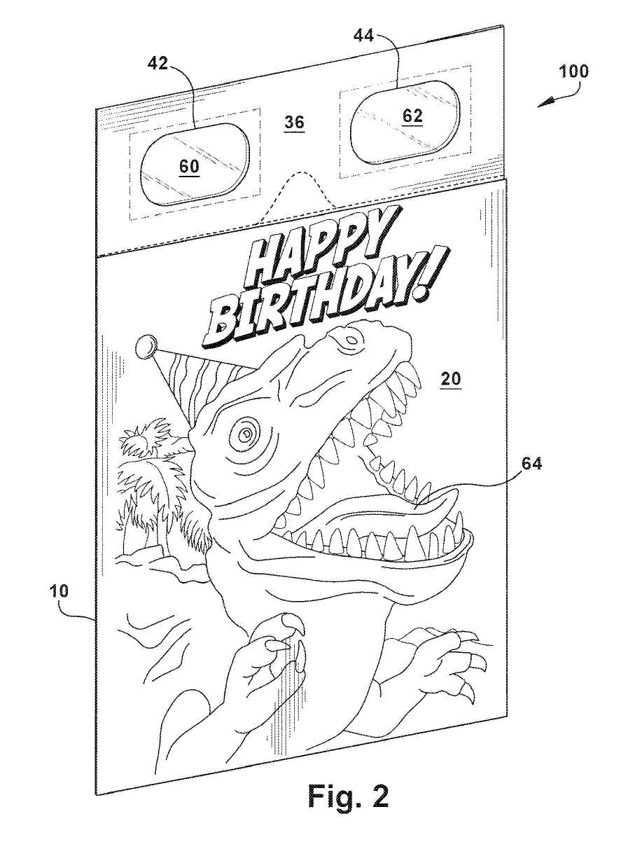

A top view of the back side of a card blank for the 3D greeting card with glasses of the present invention is shown in FIG. 1. The body 70 of the greeting card 100 includes a first panel 10 attached to a second panel 12 along a first fold line 16 and a third panel 14 that is attached to the second panel 12 along a second fold line 18. Each panel has a front side and a back side. The back side of the first panel 10 serves as the front or cover 20 of the greeting card 100. The front sides of the first 10 and second 12 panels serve as the two inside panels 22, 24 of the greeting card 100. The front side of the third panel 14 serves as the hack side 26 of the greeting card 100. Each of the panels may contain artwork and/or text sentiment printed thereon. The third panel 14 contains several perforations that can be used to either hang or display the greeting card 100 on a wall or hanging device or display the greeting card upon a table top using an extendable easel arm 28. The third panel 14 is folded along the second fold line 18 so that the back side 30 of the third panel 14 is in direct contact with the back side 32 of the second panel 12 and is securely attached thereto. In a preferred embodiment as shown, the third panel 14 is attached to the second panel 12 using one or more adhesive strips 72. The first panel 10 is folded along the first fold line 16 so that the front side 22 of the first panel 10 is in direct contact with the front side 24 of the second panel 12. The card 100 is then opened and closed by pivoting the first panel 10 about the first fold line 16. When the greeting card 100 is folded or closed and displayed for retail, the front cover 20 of the greeting card with anaglyph image 64 and the attached glasses 34 are visible to the consumer, as shown in FIG. 2. Although the greeting card body 70 has been described herein as having three panels connected along two fold lines, it is anticipated that the greeting card may have any number of greeting card panels which are connected along one or more fold lines and are arranged in a variety of configurations.

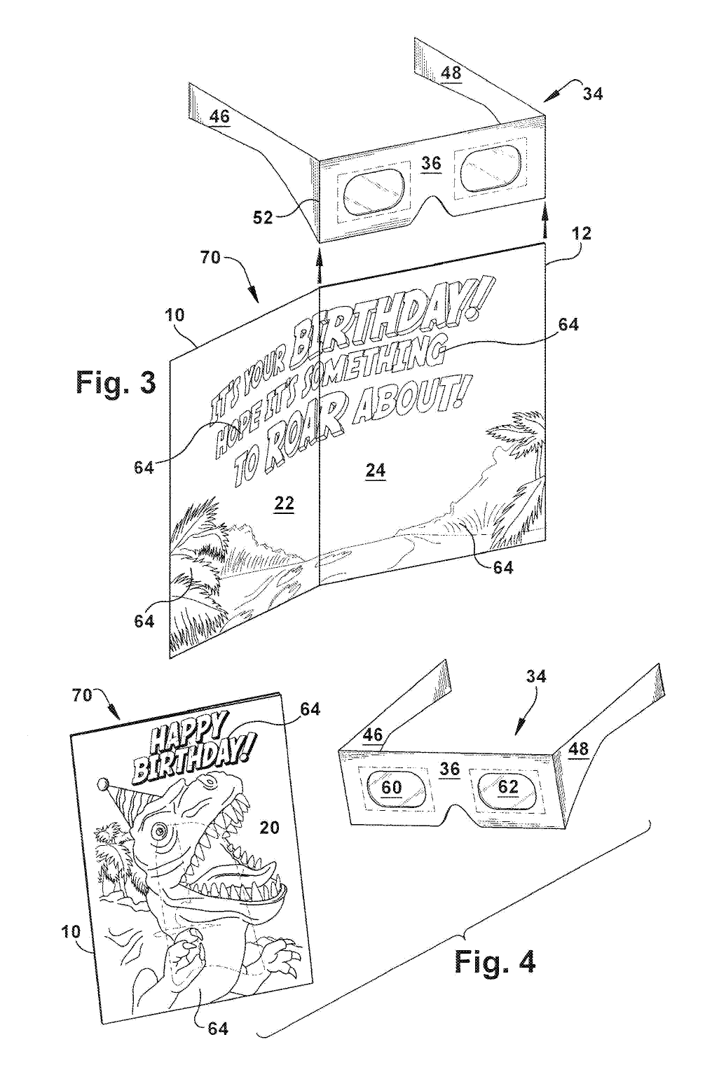

The 3D glasses (“glasses”) 34 are releasably attached to the greeting card body 70 along one edge of the greeting card 100, as shown in FIGS. 3 and 4. The 3D glasses 34 include a center or lens portion 36 which includes a front portion 38 and a back portion 40, each portion having two round or oval eye holes 42, 44 separated by a bridge or notch, a left arm 46, and a right arm 48. The left arm 46 is attached to the center or lens portion 36 of the glasses 34 along a first fold line 50 and the right arm 48 is attached to the opposite side of the center or lens portion 36 of the glasses 34 along a second fold line 52. The center or lens portion 36 of the glasses 34 is releasably attached along the bottom edge to the top edge of the second greeting card panel 12. The left arm 46 is attached along the bottom edge to the top edge of the third panel 14 of the greeting card 100. The right arm 48 is folded along the second fold line 52 so that when the third greeting card panel 14 is attached to the second greeting card panel 12, the right arm 46 of the glasses 34 securely fits between the center or lens portion 36 of the glasses (attached to the second panel 12) and the left arm 46 of the glasses (attached to the third panel 14). In a preferred embodiment, as described, the 3D glasses 34 are attached to the greeting card body 70 along the top edge of the greeting card 100, however the glasses 34 may alternatively be attached along the bottom or side edge of the greeting card body 70. The glasses 34 are releasably attached to the greeting card via perforated lines, which makes removal of the glasses 34 very easy, and does not in any way change the appearance of the greeting card 100. It also allows the greeting card body 70 and the glasses 34 to remain as one solitary structural unit while the greeting card 100 is being displayed for purchase. This prevents the glasses 34 from being accidentally or otherwise removed from the greeting card body 70 before purchase or before giving the card to the recipient. It also allows for easy shipping, storage and display in a retail environment. The entire unit can also fit into a conventional greeting card envelope for mailing or otherwise presenting the greeting card to a recipient. While perforated lines are the preferred attachment mechanism, other releasable attachment mechanisms may be used.

The 3D glasses 34 are made out of the same material as the greeting card, which is preferably cardstock. Other suitable materials such as cardboard or lightweight plastic may be used. Once the glasses 34 are removed from the 70 of the greeting card 100 by tearing along the perforations, the glasses 34 contain additional perforations which must be removed before using the glasses. For example, a perforated line 54 exists between the two eye holes 42, 44 along the bridge. Removal of this extraneous paperboard allows the glasses 34 to be placed more comfortably upon the bridge of ones nose. Extra paperboard also exists on the right 46 and left arm 48 portions of the glasses 34. This extra material can also he removed along the perforated lines 56, 58 so that the right and left arms 46, 48 contain a more curved structure to provide a more secure fit behind ones ears. The extra pieces of paperboard can be removed along the perforations 56, 58 and disposed of.

Two thin sheets of filter material 60, 62 are contained within the two eye openings 42, 44 contained on the center or lens portion 36 of the glasses 34. Typically, the left eye opening 42 contains a red filter 60 and the right eye opening 44 contains a blue filter 62. The filters 60, 62 operate as a lens through which the user will view the stereoscopic images 64 contained on and within the 3D greeting card 100. Each filter sheet 60, 62 are attached to and sandwiched between the front 38 and back 40 portions of the lens portion 36 of the glasses 34. The back portion 38 is folded downward along a fold line and attached to the front portion 40 using adhesive strips or other such attachment mechanism. The stereoscopic images and/or text 64 contained on and within the greeting card 100 are made up of two versions of the same image superimposed upon one another so that one image is in a slightly different lateral position with respect to the other image. One of the images is printed using a color that will be picked up by the left eye lens containing the red filter 60 and the other image is printed using a color that will be picked up by the right eye lens containing the blue filter 62. Each lens 60, 62 provides the user with a different viewing perspective, thus giving the illusion of depth.

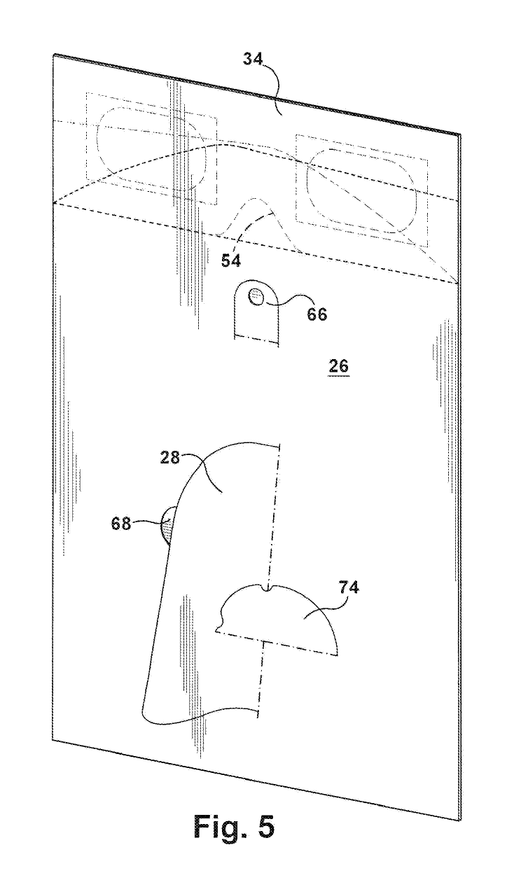

The third panel 14 of the greeting card body 70. shown in FIG. 5, which also serves as the back panel 30 of the greeting card 100, contains several perforations which can he used to display the greeting card 100. For example, near the top edge of the panel, a perforated, arched line with an aperture thereon 66 can be used to hang the greeting card 100 on a hook or other type of display hardware. Also, near the bottom edge of the greeting card, a series of perforated lines exist that when detached, create an easel arm 28 and lock 74 which protrude outward from the back of the greeting card 100 so that the greeting card 100 may be displayed on a table top. A small notch or opening 68 in the greeting card panel 14 may be used to grip and extend the easel arm 28 outward from the greeting card body 70. Once the easel arm 28 is placed in a position that is substantially perpendicular to the greeting card body 70, the lock 74 can also be placed in a position perpendicular to the greeting card body such that it fits within a notch in the easel arm 28 to lock the easel arm 28 in its outward position. Each of these display features, if not in use, lay flush with the back surface 30 of the greeting card 100.

Another embodiment of the greeting card of the present invention additionally contains a pocket located on the inside surface of the greeting card that may be used to hold movie tickets. The 3D text and/or images may he of a movie character or may be otherwise complementary to a theme or occasion represented by the movie tickets. The pocket can alternatively be used to contain a gift card, cash, a picture or other relatively thin token or memento.

Still another embodiment of the greeting card additionally contains a pocket or sleeve that may contain a CD, DVD or thumb drive. The DVD or thumb drive may contain a 3D movie or 3D images that can be viewed using the 3D viewer glasses. The text and/or graphics contained on the body of the greeting card may compliment or contain a similar theme as the data contained on the CD, DVD or thumb drive. Similarly, the CD may contain music that is in some way related to the text and/or graphics contain on and within the greeting card.

Yet another embodiment of the greeting card may contain additional features such as sound capabilities which include a sound module with the capability to store pre-recorded sound files to be played upon opening of the greeting card or by some type of user interaction. The sound module may additionally contain the capabilities to record, store and replay personalized user-recorded messages. The sound module may be concealed between two or more panels of the greeting card body and may be activated by a switch. In addition to sound functions, the 3D greeting card of the present invention may additionally contain illuminating features such as one or more LED. Switches used in combination with sound and/or light features may include a slide switch, magnetic switch, light activated switch, sound activated switch, and/or a pull tab switch.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will he appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A greeting card comprising:
a greeting card body having two or more greeting card panels connected along one or more fold lines and having at least one anaglyph image printed thereon;
a pair of 3D viewing glasses having a right lens filter and a left lens filter, the right lens filter being a different color than the left lens filter;
the pair of 3D viewing glasses releasably attached to the greeting card body;
wherein when the at least one anaglyph image printed on the greeting card body is viewed through the pair of 3D viewing glasses, the at least one anaglyph image appears to he three-dimensional.

2. The greeting card of claim 1, wherein the pair of 3D viewing glasses are connected to the greeting card body along a perforated line.

3. The greeting card of claim 1, wherein the pair of 3D viewing glasses are connected to the greeting card body along a top edge of the greeting card body.

4. The greeting card of claim 1, wherein the pair of 3D viewing glasses are connected to the greeting card body along a side edge of the greeting card body.

5. The greeting card of claim 1, wherein the pair of 3D viewing glasses are connected to the greeting card along a bottom edge of the greeting card body.

6. The greeting card of claim 1, wherein the greeting card body contains a first panel connected to a second panel along a first fold line, the second panel connected to a third panel along a second fold line.

7. The greeting card of claim 1, wherein a back side of the greeting card contains an easel arm.

8. The greeting card of claim 1, wherein a back side of the greeting card contains means by which the greeting card may be displayed upon a display hook.

9. The greeting card of claim 1, wherein the pair of 3D viewing glasses and the greeting card body are made of the same material.

10. The greeting card of claim 1, wherein the pair of 3D viewing glasses and the greeting card body are one solitary structural unit.

11. A greeting card comprising:
a multi-panel greeting card body having a front surface, an inside surface, and a back surface;
a pair of 3D viewing glasses releasably attached to the greeting card body, the 3D viewing glasses having one red lens filter and one blue lens filter;
one or more anaglyph images printed on the greeting card body;
means for hanging or displaying the greeting card located on the back surface of the greeting card body;
wherein viewing the one or more anaglyph images through the pair of 3D viewing glasses make the one or more anaglyph images appear in 3D.

12. The greeting card of claim 11, wherein the pair of 3D viewing glasses are attached to an edge of the multi-panel greeting card body along a perforated line.

13. The greeting card of claim 11, wherein the means for hanging or displaying the greeting card is an easel arm.

14. The greeting card of claim 11, wherein the pair of 3D viewing glasses are attached to at least two panels of the multi-panel greeting card body.

15. The greeting card of claim 11, wherein one anaglyph image is printed on the front surface of the greeting card.

16. The greeting card of claim 11, wherein one anaglyph image is printed on the inside surface of the greeting card.

17. The greeting card of claim 11, wherein one anaglyph image is printed on the front surface of the greeting card and one anaglyph image is printed on the inside surface of the greeting card.

18. The greeting card of claim 13, wherein the easel arm is part of the hack surface of the greeting card.

19. The greeting card of claim 11, further including a pocket located on the inside surface of the greeting card.

20. The greeting card of claim 11, wherein the greeting card body and the pair of 3D viewing glasses are made of the same material.
